(19) United States
(12) Patent Application Publication
(10) Pub. No.: US 2012/0234081 A1
(43) Pub. Date: Sep. 20, 2012

(54) CONTROLLED STRESS EXTENSIONAL RHEOMETER

(76) Inventors: Joao Maia, Shaker Heights, OH (US); Ricardo Andrade, Shaker Heights, OH (US); Patrick Harris, Cleveland, OH (US)

(21) Appl. No.: 13/424,009

(22) Filed: Mar. 19, 2012

Related U.S. Application Data
(60) Provisional application No. 61/453,610, filed on Mar. 17, 2011.

(51) Int. Cl. G01N 11/00

(52) U.S. Cl. 73/54.01

(57) ABSTRACT

An apparatus or rheometer for determining the extensional properties of a material having first and second ends includes first and second rollers gripping the first end of the material. Third and fourth rollers grip the second end of the material. An input shaft rotates the first, second, third and fourth rollers to pull the first and second ends of the material in opposite directions to stretch the material.

### RELATED APPLICATION

This application claims priority from U.S. Provisional Application No. 61/453,610, filed Mar. 17, 2011, the subject matter of which is incorporated herein by reference in its entirety.

### GOVERNMENT FUNDING

This invention was made with government support under Grant No. RES504775 awarded by The National Science Foundation. The United States government may have certain rights to the invention.

### TECHNICAL FIELD

The invention relates to rheometers and, in particular, relates to a controlled stress/rate extensional rheometer for testing highly viscous materials up to the point of rupture.

### BACKGROUND

Extensional rheology of entangled polymer melts has been the subject of a relatively strong computational, theoretical, and experimental effort over the years because many industrially important processes, such as fiber and melt spinning, film blowing, and blow molding, are dominated by the fluids' extensional properties. Also, the study of this type of flow allows an insight into the molecular structure of the materials to be gained, since extensional behavior is very dependent on the particular structure, e.g., molecular weight, molecular weight distribution, degree of branching, etc.

Understanding the mechanisms of failure and rupture of polymer liquids under extensional flow, in particular, is critically important to understand and control such phenomena as melt filament breakage in fiber formation, the appearance of surface roughness (sharkskin) in melt extrusion from a die or the onset of gross melt fracture, also in melt extrusion from a die. Despite a relatively strong computational, theoretical, and experimental effort over the years, a clear picture of the failure and rupture dynamics of entangled polymer melts in extension is still nonexistent.

Tensile creep experiments are very relevant not only because steady-state is more quickly achieved than constant strain rate conditions, but also because they are prime candidates to provide insights into possible rupture mechanisms, the liquid-solid transition, and into flow instabilities related with extension-dominated phenomena, such as sharkskin and melt fracture, which are essentially stress dependent and are very important in limiting the optimization of operating windows during processing sequences.

Although a wide body of work exists on controlled-rate extensional rheometry for polymer melts, the more recent of which focus on ease of use and modularity (Maia et al. (1999) and Sentmanat (2004)), there have been only three known attempts in recent times at developing controlled-stress capabilities. The Maia device used a filament stretching device to control the stress via a feedback loop of the tensile force, which decreases in time in order to keep the stress in the sample constant; this solution, however, is limited by the achievable length of the sample and the assumption that deformation is homogeneous throughout the entire sample. The Sentmanat device consisted of imposing an exponentially decreasing force to the sample in order to keep the stress constant. Again, the main limitations are the low achievable Hencky strains and the assumption of deformation homogeneity. The third one was developed recently by Maia and co-workers (Maia et al. (2008)) and is composed of a fixed clamp and a rotating clamp with two counter-rotating rollers that pull the sample. Although Maia (2008) can test materials until physical rupture it still has limitations, such as the fact that it requires an oil bath to maintain buoyancy and for temperature control, and also because it resorts to only one pair of counter-rotating rollers, which means the flow tends to become non-homogeneous at high strains due to the different boundary conditions at the fixed clamp and at the moving rollers. Therefore, no existing rheometer can perform true tensile creep experiments up until the physical rupture of the sample

### SUMMARY OF THE INVENTION

The objective of the present invention is to overcome for the first time all the limitations described above, by developing a true dual mode Controlled Stress/Rate Extensional Rheometer (CSER), that can homogeneously test highly viscous materials up to the point of physical rupture.

An object of the present invention is to provide a rheometer capable of studying the rupture mechanisms in the uniaxial extension of polymer melts.

The present invention is directed to an apparatus or a rheometer for determining the extensional properties of a material having first and second ends. The apparatus includes first and second rollers gripping the first end of the material. Third and fourth rollers grip the second end of the material. An input shaft rotates the first, second, third and fourth rollers to pull the first and second ends of the material in opposite directions to stretch the material.

Other objects and advantages and a fuller understanding of the invention will be had from the following detailed description of the preferred embodiments and the accompanying drawings.

### BRIEF DESCRIPTION OF THE DRAWINGS

FIG. 1 is a schematic illustration of a controlled stress extensional rheometer (CSER) in accordance with the present invention;

FIG. 2 is an exploded view of the rheometer of FIG. 1;

FIG. 3 is an enlarged view of a portion of FIG. 2 showing an upper body of the rheometer;

FIG. 4 is an enlarged view of a portion of FIG. 2 showing a lower body of the rheometer;

FIG. 5 is a front view of the rheometer of FIG. 1;

FIG. 6 is a side view of the rheometer of FIG. 1; and

FIG. 7 is an exploded schematic illustration of a calibration assembly for the rheometer of FIG. 1.

### DETAILED DESCRIPTION OF AN EXEMPLARY EMBODIMENT

The invention relates to rheometers and, in particular, relates to a controlled stress/rate extensional rheometer for testing highly viscous materials up to the point of rupture. Since both ends of the test material are held and stretched by counter-rotating rollers, the test material used in the rheometer of the present invention experiences similar strain histories at both ends of the sample, thereby providing more accurate data, e.g., extensional viscosity, relating to the failure of the test sample.

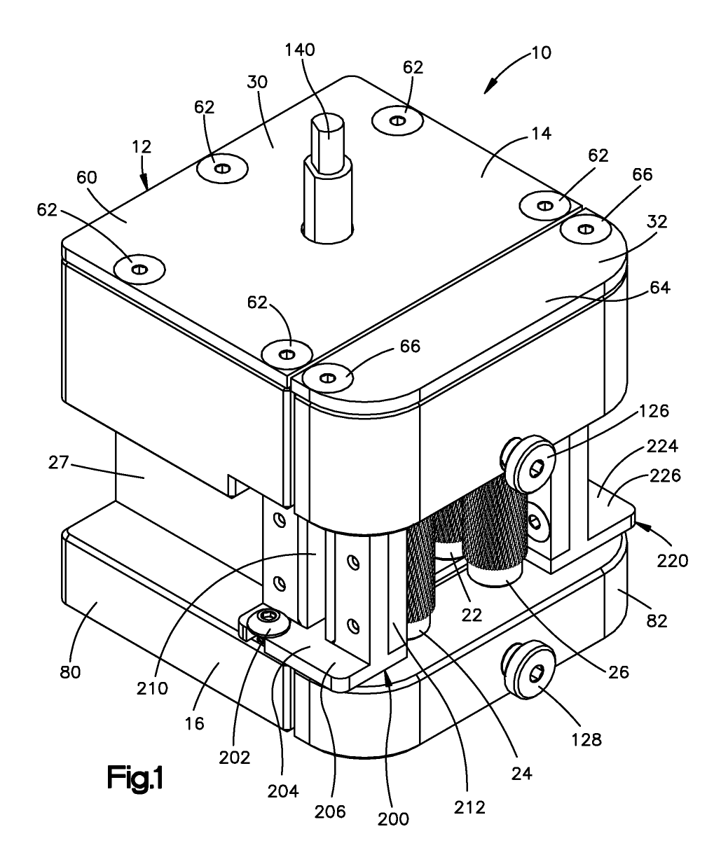

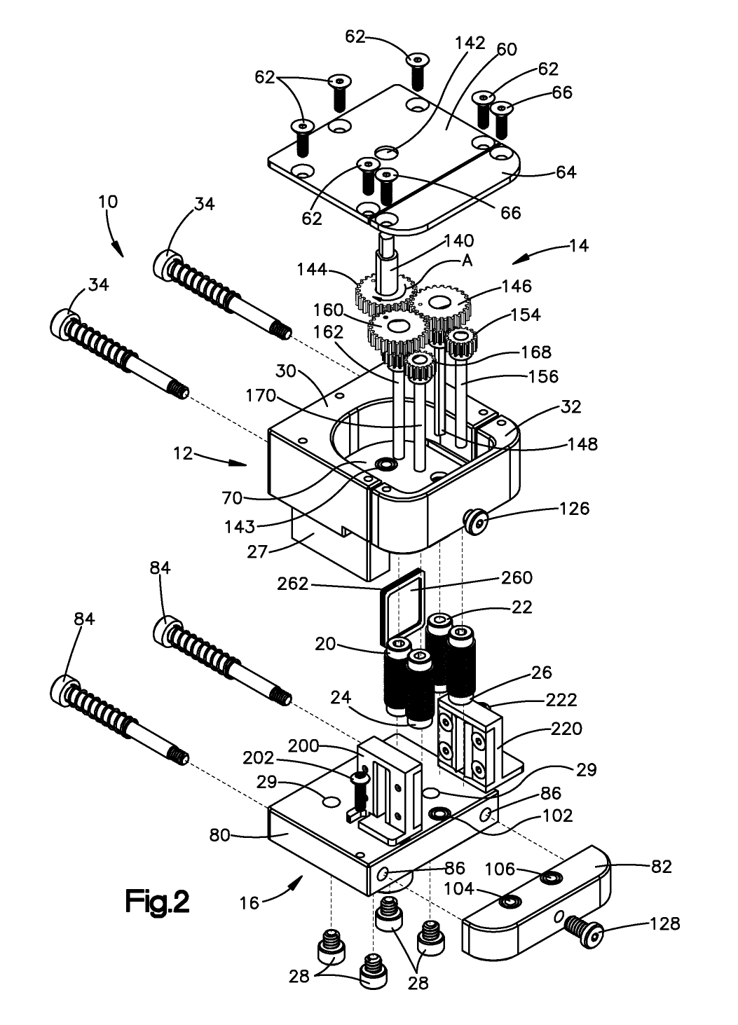

A rheometer 10 constructed in accordance with the present invention is illustrated in FIGS. 1-6. The rheometer 10 (FIGS. 1 and 2) includes a housing 12 having an upper body 14 and a lower body 16. The upper body 14 and the lower body 16 support rollers 20, 22, 24, and 26 for rotation relative to the housing 12. The rollers 20, 22, 24 and 26 extend between the upper and lower bodies 14 and 16. The rollers 20, 22, 24, and 26 have roughened surfaces for gripping a sample of material to be tested by the rheometer.

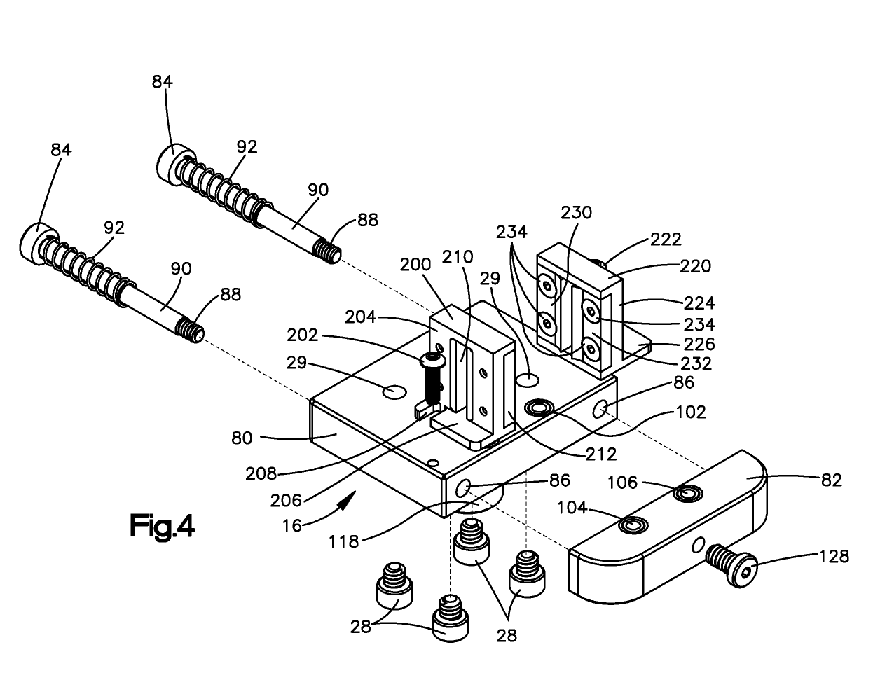

The upper body 14 has downwardly extending walls 27, one of which is shown in FIG. 2, engaging the lower body 16. The walls 27 have threaded openings that receive fasteners 28 to connect the upper body 14 to the lower body 16. The fasteners 28 extend through openings 29 in the lower body 16, two of which are shown in FIGS. 2 and 4, and threadably engage the openings in the walls 27 to interconnect the upper body 14 and the lower body. The walls 27 extend generally parallel to each other and define an empty space or window extending through the rheometer 10. The empty space or window may be used to obtain x-ray scattering data of a sample of material in the rheometer 10.

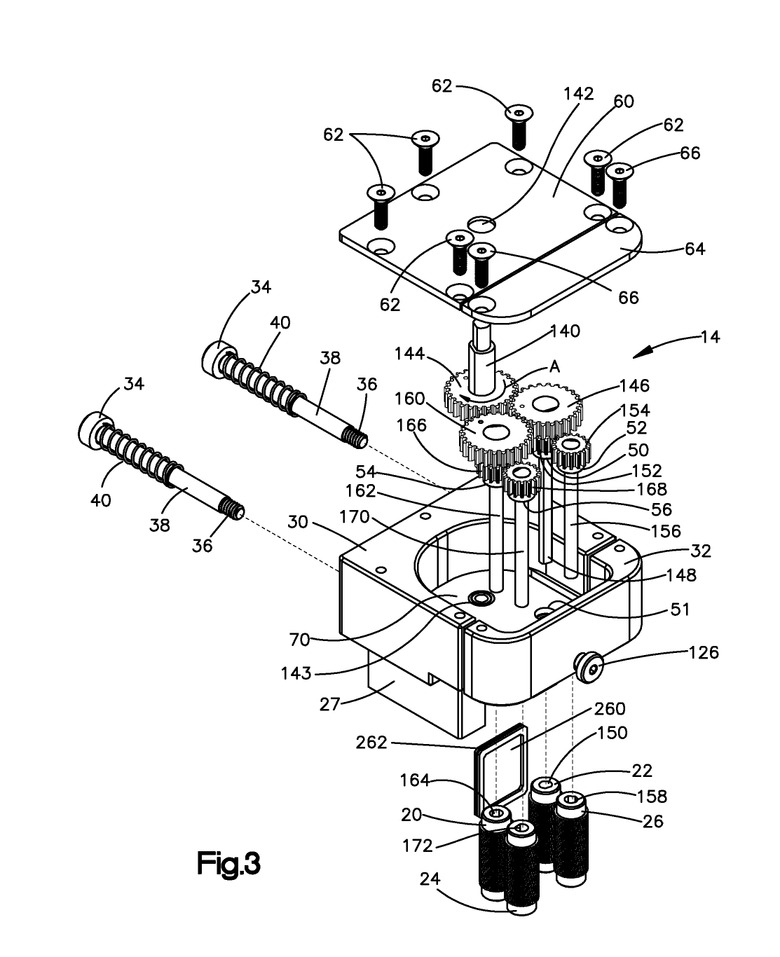

The upper body 14 (FIGS. 2 and 3) includes a first or back portion 30 and a second or front portion 32. The first portion 30 is connected to the second portion 32 by fasteners 34. Each of the fasteners 34 extends through an opening (not shown) in the first portion 30. The fasteners 34 (FIG. 3) have threaded end portions 36 that threadably engage the second portion 32. A shaft 38 of the fastener 34 extends through a coil spring 40 and the opening in the first portion 30. The coil spring 40 engages a head of the fastener 34 and a shoulder (not shown) in the opening of the first portion 30. The springs 40 urge the first and second portions 30, 32 of the upper body 14 into engagement with each other. The springs 40 also allow the second portion 32 to move relative to the first portion 30. When the second portion 32 moves relative to the first portion 30, the fasteners 34 slide in the openings in the first portion.

The first portion 30 of the upper body 14 includes a cover 60. The cover 60 is connected to the first portion 30 by fasteners 62. The second portion 32 includes a cover 64. The cover 64 is connected to the second portion 32 by fasteners 66. The covers 60 and 64 close a recess 70 located in the upper body 14.

The lower body 16 (FIGS. 2 and 4) includes a first or back portion 80 and a second or front portion 82. The first portion 80 is connected to the second portion 82 by fasteners 84. The fasteners 84 are substantially similar to the fasteners 34. Each of the fasteners 84 (FIG. 4) extends through an opening 86 in the first portion 80. The fasteners 84 have threaded end portions 88 that threadably engage the second portion 82. A shaft 90 of the fastener 84 extends through a coil spring 92 and the opening 86 in the first portion 80. The coil spring 92 engages a head of the fastener 84 and a shoulder (not shown) in the opening 86 of the first portion 80. The springs 92 urge the first and second portions 80, 82 of the lower body 16 into engagement with each other. The springs 92 also allow the second portion 82 to move relative to the first portion 80. When the second portion 82 moves relative to the first portion 80, the fasteners 84 slide in the openings in the first portion.

The first portion 80 of the lower body 16 includes bearings 102 (one of which is shown in FIGS. 2 and 4) supporting the rollers 20 and 22 for rotation relative to the lower body 16. The second portion 82 of the lower body 16 includes bearings 104, 106 supporting the rollers 24 and 26 for rotation relative to the lower body 16. The rollers 24 and 26 move with the second portion 82 of the lower body 16 relative to the first portion 80. Therefore, the rollers 24, 26 move relative to the rollers 20, 22 when the second portion 82 moves relative to the first portion 80.

The lower body 16 (FIGS. 4-6) includes a cylindrical mounting member 118 for connecting the rheometer 10 in an environmental chamber for controlling the temperature of a sample of material being tested by the rheometer. The mounting member 118 connects to a lower shaft extending into the environmental chamber. The environmental chamber may be an oven or oil bath of a known rotational rheometer. Although the rheometer 10 is shown with a cylindrical projection extending from the lower body 16, it is contemplated that the rheometer may be mounted in an environmental chamber in any desired manner.

The second portion 32 (FIGS. 1 and 2) of the upper body 14 includes a member 126 extending away from the first portion 30 of the upper body. The second portion 82 of the lower body 16 includes a member 128 extending away from the first portion 80 of the lower body. The members 126 and 128 are shown as fasteners threaded into openings in the second portions 32 and 82, however, the members may be formed as one piece with the second portions. A tool (not shown) engages the members 126 and 128 to allow the second portions 32 and 82 to be moved simultaneously relative to the first portions 30 and 80 of the upper and lower bodies 14 and 16. When the tool is engaged with the members 126 and 128 and pulled away from the first portions 30 and 80 of the upper and lower bodies 14 and 16, the second portions 32 and 82 move away from the first portions and the rollers 24 and 26 move away from the rollers 20 and 22. The fasteners 34 and 84 slide in the openings in the first portions 30 and 80 and compress the springs 40 and 92 as the second portions 32 and 82 move out of engagement with the first portions.

A first end of a sample of material to be tested is inserted between the rollers 20 and 24 and the opposite, second end of the sample is inserted between the rollers 22 and 26. Once the first end of the sample is inserted between the rollers 20 and 24 and the second end is inserted between the rollers 22 and 26 the tool may be released. The springs 40 and 92 move the second portions 32 and 82 into engagement with the first portions 30 and 80. The rollers 20 and 24 clamp the first end of the sample of material and the rollers 22 and 26 clamp the second end of the sample. The springs 40 and 92 apply clamping forces to the first and second ends of the sample of material. The clamping forces applied by the springs 40 and 92 can be adjusted by rotating the fasteners 34 and 84 and/or by placing stronger or weaker springs 40 and 92 over the fasteners.

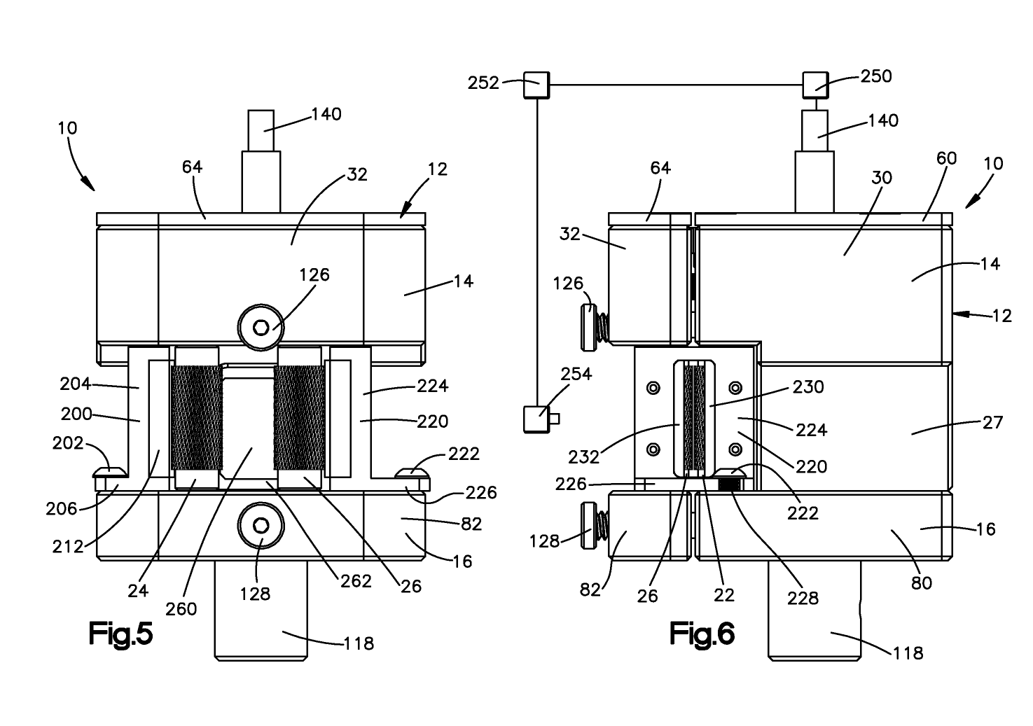

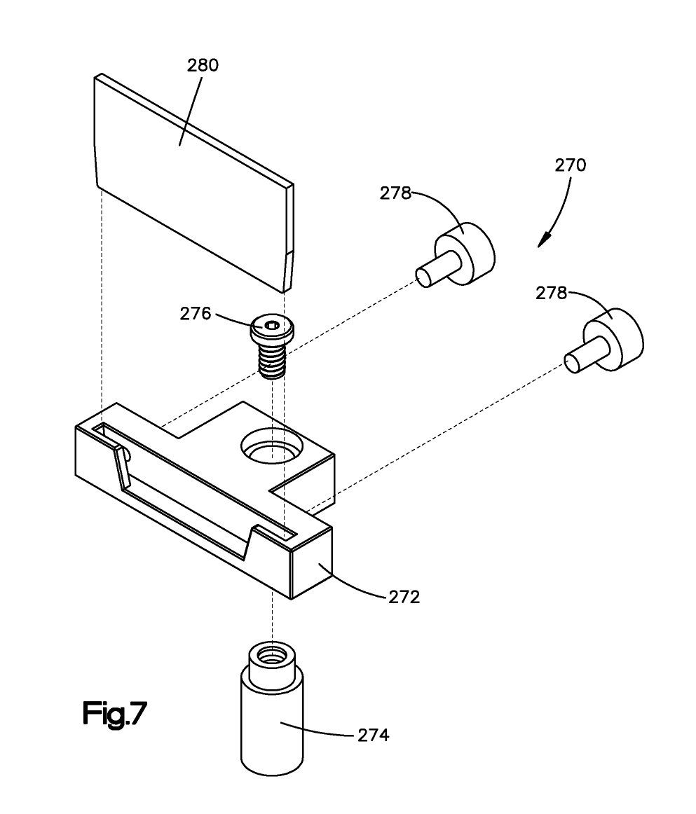

A drive shaft or input shaft 140 (FIGS. 2 and 3) extends through an opening 142 in the cover 60 of the upper body 14 into the recess 70. A bearing 143 in the first portion 30 of the upper body 14 supports the input shaft 140 for rotation relative to the upper body 14. The axis of the input shaft 140 extends closer to the rollers 22 and 26 than to the rollers 20 and 24, as seen in FIG. 5. However, the input shaft 140 is centered relative to the housing 12. A side wall of the upper body 14 (FIG. 3) closest to the input shaft 140 is thicker than an opposite side wall of the upper body to balance the rheometer so that the center of gravity of the rheometer extends through the input shaft 140.

The input shaft 140 has a D-shaped cross-section that engages a gear 144 in the recess 70. The gear 144 is in meshing engagement with a gear 146 connected to an axle 148 for the roller 22. A bearing 50 in an opening 51 in the first portion 30 of the upper body 14 supports the axle 148 for rotation relative to the first portion.

The axle 148 (FIGS. 2 and 3) has a D-shaped cross-section that slidably engages an axially extending D-shaped opening 150 in the roller 22. Therefore, the roller 22 rotates with the axle 148 relative to the upper body 14 of the housing 12. The axle 148 extends through the bearing 50, through the roller 22 and into one of the bearings 102 in the first portion 80 of the lower body 16. Thus, the bearings 50 and 102 support the axle 148 and the roller 22 for rotation relative to the housing 12.

A second gear 152 is connected to the axle 148 axially below the gear 146. The second gear 152 of the axle 148 meshes with a gear 154 connected to an axle 156. A bearing 52 in an opening (not shown) in the second portion 32 of the upper body 14 supports the axle 156 for rotation relative to the second portion.

The axle 156 has a D-shaped cross-section that slidably engages an axially extending D-shaped opening 158 in the roller 26. Therefore, the roller 26 rotates with the axle 156 relative to the upper body 14 of the housing 12. The axle 156 extends through the bearing 52 in the second portion 32 of the upper body 14, through the roller 26 and into the bearing 106 in the second portion 82 of the lower body 16. Thus, the bearings 52 and 106 support the axle 156 and the roller 26 for rotation relative to the housing 12.

The gear 146 of the axle 148 also meshes with a gear 160 in the recess 70. The gear 160 is connected to an axle 162 for the roller 20. A bearing 54 in an opening (not shown) in the first portion 30 of the upper body 14 supports the axle 162 for rotation relative to the first portion.

The axle 162 has a D-shaped cross-section that slidably engages an axially extending D-shaped opening 164 in the roller 20. Therefore, the roller 20 rotates with the axle 162 relative to the upper body 14 of the housing 12. The axle 162 extends through the bearing 54, through the roller 20 and into the other bearing 102 in the first portion 80 of the lower body 16. Thus, the bearings 54 and 102 support the axle 162 and the roller 20 for rotation relative to the housing 12.

A second gear 166 is connected to the axle 162 axially below the gear 160. The second gear 166 of the axle 162 meshes with a gear 168 connected to an axle 170. A bearing 56 in an opening (not shown) in the second portion 32 of the upper body 14 supports the axle 170 for rotation relative to the second portion.

The axle 170 has a D-shaped cross-section that slidably engages an axially extending D-shaped opening 172 in the roller 24. Therefore, the roller 24 rotates with the axle 170 relative to the upper body 14 of the housing 12. The axle 170 extends through the bearing 56 in the second portion 32 of the upper body 14, through the roller 24 and into the bearing 104 in the second portion 82 of the lower body 16. Thus, the bearings 56 and 104 support the axle 170 and the roller 24 for rotation relative to the housing 12.

Although the axles are described as having D-shaped cross-sections for transmitting torque between the axles, gears and rollers, the axles may be connected to the gears and rollers in any desired manner. The axles, gears and rollers may have splined connections that transmit torque between the axles, gears and rollers. It is also contemplated that the axles, gears and rollers may be formed as one piece.

The input shaft 140 rotates in a clockwise direction indicated by arrow A in FIG. 2. Rotation of the input shaft in the clockwise direction A causes rotation of the gear 146, axle 148, gear 152 and roller 22 in the counterclockwise direction. Rotation the gear 152 in the counterclockwise direction causes the gear 154, axle 156 and roller 26 to rotate in a clockwise direction. Therefore, the rollers 22 and 26 rotate in opposite directions.

The gear 160, axle 162, gear 166 and roller 20 rotate in a clockwise direction in response to rotation of the gear 146 in the counterclockwise direction. Rotation of the gear 166 in the clockwise direction causes the gear 168, axle 170 and roller 24 to rotate in a counterclockwise direction. Therefore, the rollers 20 and 24 rotate in opposite directions.

The first end of the sample of material is placed between the rollers 20 and 24 and the second end of the sample is placed between the rollers 22 and 26. When the input shaft 140 rotates in the clockwise direction, the rollers 20 and 24 rotate in opposite directions and the rollers 22 and 26 rotate in opposite directions. Therefore, the sample of material is elongated by the rollers. The axis of the roller 20 is a fixed distance from the axis of the roller 22. The axis of the roller 24 is a fixed distance from the axis of the roller 26. However, the achievable length of the sample of material is not limited to a specific distance since the sample is fed between each pair of rollers.

A material scraper 200 (FIGS. 2 and 4) prevents the sample of material from wrapping around the rollers 20 and 24. The material scraper 200 is connected to the lower body 16 adjacent the rollers 20 and 24 by a fastener 202. The material scraper 200 (FIG. 4) includes a scraper housing 204 with a flange 206. The fastener 202 extends through slot 208 in the flange 206 to connect the housing 204 to the lower body 16. The slot 208 allows the material scraper 200 to be slid into a desired position relative to the rollers 20 and 24.

The material scraper 200 includes a first scraper 210 adjacent the roller 20 and a second scraper 212 adjacent the roller 24. The first and second scrapers 210 and 212 are connected to the scraper housing 204 by fasteners (not shown). Therefore, the first and second scrapers 210 and 212 can be replaced easily if necessary. The first scraper 210 scrapes the sample of material from the roller 20 and the second scraper 212 scrapes the sample from the roller 24 during rotation of the rollers.

A material scraper 220 prevents the sample of material from wrapping around the rollers 22 and 26. The material scraper 220 is connected to the lower body 16 adjacent the rollers 22 and 26 by a fastener 222. The material scraper 220 includes a scraper housing 224 with a flange 226. The fastener 222 extends through a slot 228 (FIG. 6) in the flange 226 to connect the housing 224 to the lower body 16. The slot 228 allows the material scraper 220 to be slid into a desired position relative to the rollers 22 and 26.

The material scraper 220 (FIG. 4) includes a first scraper 230 adjacent the roller 22 and a second scraper 232 adjacent the roller 26. The first and second scrapers 230 and 232 are connected to the scraper housing 224 by fasteners 234. Thus, the first and second scrapers 230 and 232 can be replaced if necessary. The first scraper 230 scrapes the sample of material from the roller 22 and the second scraper 232 scrapes the sample from the roller 26 during rotation of the rollers.

The use of the rheometer 10 will now be described in more detail. The lower body 16 may be disconnected from the upper body 14 by removing the fasteners 28. The rollers 20, 22, 24, and 26 may be removed from the axles 148, 156, 162, and 170 once the lower body 16 is disconnected for the upper body. Therefore, rollers having a desired surface for gripping a sample of material may be placed in the rheometer 10. Accordingly, different sets of rollers 20, 22, 24, and 26 with different surfaces may be used depending on the material of the sample to be tested.

Once the desired rollers 20, 22, 24 and 26 are connected to the rheometer 10, the material scrapers 200 and 220 may be positioned relative to the rollers. The fasteners 202 and 222 may be loosened to allow the scrapers 200 and 202 to slide relative to the lower body 16. The fasteners 202 and 222 are tightened to clamp the scrapers 200 and 202 in the desired positions.

A tool (not shown) is connected to the members 126 and 128 on the second portions 32 and 82 of the upper and lower bodies 14 and 16. The tool is pulled away from the first portions 30 and 80 of the upper and lower bodies 14 and 16. The second portions 32 and 82 move out of engagement with the first portions 30 and 80. The rollers 24 and 26 move away from the rollers 20 and 22 when the second portions 32 and 82 move relative to the first portions 30 and 80. Thus, a gap forms between the rollers 20 and 24 and a gap forms between the rollers 22 and 26. A first end of the sample of material is placed in the gap between the rollers 20 and 24 and a second end of the sample is placed in the gap between the rollers 22 and 26.

After the ends of the sample are placed between the rollers, the springs 40 and 92 move the second portions 32 and 82 into engagement with the first portions 30 and 80 upon release of the tool. The rollers 24 and 26 move toward the rollers 20 and 22 to reduce the gaps between the rollers. The rollers 20 and 24 grip the first end of the sample of material and the rollers 22 and 26 grip the second end of the sample. The gripping force applied by the rollers 20, 22, 24 and 26 may be adjusted by rotating the fasteners 34 and 84 to change the force applied by the coil springs 40 and 92. Therefore, a desired gripping force may be applied to the first and second ends of the sample of material.

The rheometer 10 is placed in the environmental chamber after the sample is placed in the rheometer. The environmental chamber may be an oven or oil bath of a known rotational rheometer. A motor 250 (FIG. 6) is connected with the input shaft 140. The motor 250 rotates the input shaft 140 which causes the rollers 20, 22, 24, and 26 to rotate. The motor 250 is also connected to a controller 252 for controlling the speed and torque applied by the motor 250. The rollers 20, 22, 24, and 26 extend and deform the sample of material when the input shaft 140 rotates. A high speed camera 254 records the deformation of the sample of material. The camera 254 is also connected with the controller 252 and sends a signal to the controller. The controller 252 analyzes the images received from the camera 254 to determine extensional properties of the sample of material. The controller 252 also controls the motor 250 in response to the extensional properties to operate the motor in a desired manner. The controller 252 may operate the motor 250 to maintain a constant strain rate or a constant stress in the sample. The controller 252 may operate the motor 250 in a desired manner in response to any desired extensional property.

A film or backdrop 260 (FIGS. 2, 3 and 5) held in a frame 262 may be connected to the rheometer 10. The frame 262 may extend into slots (not shown) in the walls 27 of the upper body 14. The film 260 may provide a sharp contrast to the sample of material so that the image of the deforming sample is clearly visible.

A calibration assembly 270 may be used to calibrate the camera 254 prior to placing the rheometer 10 in the environmental chamber. The calibration assembly 270 includes a base 272. The base 272 is connected to a cylindrical connecting member 274 by a fastener 276. The connecting member 274 may be connected to the lower shaft that extends into the environmental chamber. A pair of fasteners 278 clamps a calibration grid 280 to the base 272. The calibration assembly 270 is connected in the environmental chamber prior to the rheometer 10 and used to calibrate the camera 254 prior to testing a sample of material.

A first pair of rollers 20, 24 and a second pair of rollers 22, 26 are rotatably mounted via bearings and axles in a space defined between the upper body 14 and the lower body 16. Each pair of rollers includes a drive roller 20 or 22 and a driven roller 24 or 26. The spacing between the rotational axes of the drive rollers 20, 22 and the driven rollers 24, 26, respectively, is constant. The drive rollers 20, 22 are rotatably coupled to one another and a motor 250 via a series of gears 144, 146, 160.

More specifically, each drive roller 20, 22 is secured to a first gear 146, 160 in meshing engagement with each other. A second gear 144 is in meshing engagement with one of the first gears 146 and connected to a motor 250 for imparting rotation/torque to the second gear 144, which, in turn, imparts rotation/torque to both first gears 146, 160 equally. The first gears 146, 160 therefore impart rotation/torque to the drive rollers 20, 22 simultaneously and equally. The gears 144, 146, 160 may have a desired gear ratio to control the transmission of torque between the motor and the drive rollers 20, 22.

Each pair of rollers 20, 24 and 22, 26 is configured to receive an end of the material to be tested, i.e., each end of the material is held between a pair of rollers. Each roller 20, 22, 24, 26 in both pairs of rollers has a generally cylindrical shape. The periphery of the roller initially has a smooth finish that is knurled or otherwise roughened mechanically, chemically, etc. in order to increase the surface finish roughness of the roller. Preferably, all four rollers 20, 22, 24, 26 have the same roughened surface finish. The added roughness on the rollers 20, 22, 24, 26 helps to maintain a constant grip on each end of the material as it is tested. This helps to ensure that the most homogenous possible deformation up to the point of physical rupture of the sample is maintained for the widest possible range of materials. In particular, rollers 20, 22, 24, 26 having various surfaces finishes may be provided for rapidly interchanging the particular surface roughness level depending on the material being tested. Alternatively, sleeves having different surface finishes may be provided which can readily be removed and interchanged over the roller without removing the roller from the rheometer (not shown).

When a sample of material is to be tested, an end of the material is secured between each pair of drive/driven rollers 20, 24 and 22, 26. The roughened surface finish of the rollers 20, 22, 24, 26 helps to prevent slippage and uneven rotation of the rollers relative to one another. The motor 250 is then operated to rotate the input shaft 140, which causes rotation of the second gear 144 and, thus, rotation of both first gears 146, 160 in opposite directions. As each first gear 146, 160 rotates, the drive rollers 20, 22 are rotated in opposite directions. Since each drive roller 20, 22 has a gear 152, 166 in meshing engagement with a gear 154, 168 of a driven roller 24, 26, rotating each drive roller likewise causes rotation of each driven roller.

As each pair of rollers 20, 24 and 22, 26 rotates opposite to the other, the test material is uniaxially stretched or drawn in a generally outward direction away from the center of the test material. The elongation of the test material may be monitored by a high-speed camera 254. It is also contemplated that since the stretching material resists elongation and thereby provides a resistance to rotation of each roller 20, 22, 24, 26, the resistance to rotation may be monitored by sensors in a known manner. The resistance torque, motor 250 rotation, and elongation may be part of a feedback loop that uses the controller or microprocessor 252 to control, in real-time, the stress, strain, strain rate, and/or Hencky strains on the test material. The controller or microprocessor 252 may use this data to ensure that one or more of these parameters remains constant throughout testing in order to maintain homogeneity throughout the testing process up until physical rupture of the test sample.

The rheometer 10 of the present invention is advantageous in that 1) its small size ensures that it will fit into the high-temperature environmental chamber of the host rotational rheometer, 2) imposing the deformation through two pairs of counter-rotating rollers, with different interchangeable levels of surface roughness, ensures the most homogenous possible deformation up to the point of physical rupture of the sample, for the widest possible range of materials, and c) the real-time, feedback control loop allows the rheometer 10 to control both the strain rate and the tensile stress depending on the mode of operation. The elimination of the prior rheometer limitations by the above-mentioned features of the present invention allows for the study of phenomena like failure and rupture of a variety of polymers, under controlled stress, and on any standard rotational rheometer.

The preferred embodiments of the invention have been illustrated and described in detail. However, the present invention is not to be considered limited to the precise construction disclosed. Various adaptations, modifications and uses of the invention may occur to those skilled in the art to which the invention relates and the intention is to cover hereby all such adaptations, modifications, and uses which fall within the spirit or scope of the appended claims.

Having described the invention, the following is claimed:

1. An apparatus for determining the extensional properties of a material having first and second ends comprising:
first and second rollers for gripping the first end of the material;
third and fourth rollers for gripping the second end of the material;
an input shaft for rotating the first, second, third and fourth rollers to pull the first and second ends of the material in opposite directions to stretch the material;

2. An apparatus as set forth in claim 1 further including a controller for controlling the input shaft in response to at least one of the extensional properties of the material as the material is stretched by the first, second, third and fourth rollers.

3. An apparatus as set forth in claim 2 wherein the controller includes a feedback loop for controlling at least one of the strain rate and tensile stress on the material as the material is stretched by the first, second, third and fourth pair of rollers.

4. An apparatus as set forth in claim 2 wherein a camera is connected to the controller, the camera sending a signal to the controller and the controller analyzing the signal to control the input shaft.

5. An apparatus as set forth in claim 2 wherein the controller controls a motor that rotates the input shaft, the controller controlling the motor in response to at least one of the extensional properties of the material as the material is stretched by the first, second, third and fourth rollers.

6. An apparatus as set forth in claim 1 wherein at least one of the first, second, third and fourth rollers has a surface roughness that is adapted to prevent movement of the ends of the material relative to the at least one of the first, second, third and fourth rollers as the material is stretched.

7. An apparatus as set forth in claim 1 wherein the input shaft includes a gear in meshing engagement with a first gear connected with the first roller.

8. An apparatus as set forth in claim 7 wherein the first roller has a second gear in meshing engagement with a gear connected with the second roller.

9. An apparatus as set forth in claim 7 wherein said third roller includes a first gear in meshing engagement with the first gear connected with the first roller.

10. An apparatus as set forth in claim 9 wherein the third roller includes a second gear in meshing engagement with a gear connected with the fourth roller.

11. An apparatus as set forth in claim 1 wherein at least one of the first, second, third and fourth rollers is slidably connected to an axle.

12. An apparatus as set forth in claim 11 wherein the at least one of the first, second, third and fourth rollers extends between an upper body and a lower body of a housing, the upper and lower bodies retaining the at least one of the first, second, third and fourth rollers on the axle.

13. An apparatus as set forth in claim 12 wherein the lower body and the upper body are releasably connected to each other.

14. An apparatus as set forth in claim 1 wherein the first, second, third, and fourth rollers extend between an upper body and a lower body of a housing, the upper body having first and second portions movable relative to each other, the lower body having first and second portions movable relative to each other, the first and third rollers extending between the first portions of the upper and lower bodies, the second and fourth rollers extending between the second portions of the upper and lower bodies so that the second and fourth rollers are movable relative to the first and third rollers.

15. An apparatus as set forth in claim 14 wherein at least one spring urges the first and second portions of the upper and lower bodies toward each other.

16. An apparatus as set forth in claim 1 wherein the first and second rollers apply an adjustable gripping force to the first end of the material.

17. An apparatus as set forth in claim 16 wherein the third and fourth rollers apply an adjustable gripping force to the second end of the material.

18. An apparatus as set forth in claim 1 further including at least one scraper for removing the material from at least one of the first, second, third and fourth rollers.

19. An apparatus as set forth in claim 1 wherein the first, second, third and fourth rollers extend between an upper body and a lower body of a housing, the housing having side walls that define an empty space extending through the housing.

20. An apparatus as set forth in claim 1 wherein an axis of the input shaft extends through a center of gravity of the apparatus.

21. An apparatus as set forth in claim 1 further including a mounting member for connecting the apparatus in an environmental chamber for controlling the temperature of the material.

22. An apparatus as set forth in claim 4 further including a camera calibration assembly.
